(19) United States
(12) Patent Application Publication
(10) Pub. No.: US 2026/0310345 A1
(43) Pub. Date: Oct. 8, 2026

(54) DISPLAY METHOD AND APPARATUS, DEVICE, MEDIUM AND PRODUCT

(71) Applicant: Bytedance Technology Ltd., Grand Cayman (KY)

(72) Inventor: Ziyan LI, Beijing (CN)

(21) Appl. No.: 19/636,535

(22) Filed: Apr. 1, 2026

(30) Foreign Application Priority Data
Apr. 2, 2025 (CN) 202510413701.6

(51) Int. Cl. G06F 3/0488; G06F 3/0484

(52) U.S. Cl. CPC G06F 3/0488; G06F 3/0484

(57) ABSTRACT

The present disclosure provides a display method and apparatus, a computing device, a computer storage medium and a computer program product. The method includes: receiving a gesture input for an interface element, the interface element having multiple candidate anchor positions arranged in an order; determining, at least based on a velocity of the gesture input, a target anchor position from the multiple candidate anchor positions; and displaying the interface element based on the determined target anchor position.

### CROSS-REFERENCE TO RELATED APPLICATION(S)

This application claims priority to Chinese Patent Application No. 202510413701.6 filed on Apr. 02, 2025, the disclosure of which is incorporated herein by reference in its entirety.

### FIELD

The present disclosure relates to the technical field of computers, and more specifically, to a display method and apparatus, a computing device, a computer storage medium and a computer program product.

### BACKGROUND

In recent touch interaction scenarios, users move or keep an interactive element in place via drag gestures. However, in related arts, when processing multiple anchor/stay positions (e.g., in a scenario of page navigation, an image carousel, a multi-level menu, a semi-pop-up window, or the like), it is typical to adopt a determination scheme based on a displacement threshold, that is, to trigger a response merely according to the absolute value of the drag displacement and the proximity to a preset position.

### SUMMARY

In a first aspect of embodiments of the present disclosure, there is provided a display method, comprising: receiving a gesture input for an interface element, the interface element having multiple candidate anchor positions arranged in an order; determining, at least based on a velocity of the gesture input, a target anchor position from the multiple candidate anchor positions; and displaying the interface element based on the determined target anchor position.

In a second aspect of embodiments of the present disclosure, there is provided a display apparatus, comprising: an input unit configured to receive a gesture input for an interface element, the interface element having a multiple candidate anchor positions arranged in an order; a position determining unit configured to determine, at least based on a velocity of the gesture input, a target anchor position from the multiple candidate anchor positions; and a display unit configured to display the interface element based on the determined target anchor position.

In a third aspect of embodiments of the present disclosure, there is provided an electronic device, comprising: at least one processing unit; and at least one memory coupled to the at least one processing unit and storing instructions executable by the at least one processing unit, wherein the instructions, when executed by the at least one processing unit, cause the electronic device to perform the method in the first aspect of the present disclosure.

In a fourth aspect of the present disclosure, there is provided a non-transitory computer storage medium, comprising machine-executable instructions that, when executed by a device, cause the device to perform the method in the first aspect of the present disclosure.

In a fifth aspect of the present disclosure, there is provided a computer program product comprising machine-executable instructions that, when executed by a device, cause the device to perform the method in the first aspect of the present disclosure.

It would be appreciated that the Summary is not intended to identify key features or essential features of the present disclosure, nor is it intended to be used to limit the scope of the present disclosure. Other features of the present disclosure will be made apparent through the following description.

### BRIEF DESCRIPTION OF THE DRAWINGS

With reference to the following detailed description of the accompanying drawings, the above and other objectives, features, and advantages of the embodiments of the present disclosure will be made clearer. Wherein:

FIG. 1 illustrates a schematic diagram of an example environment where multiple embodiments of the present disclosure can be implemented;

FIG. 2 illustrates a flowchart of an interface display method according to some embodiments of the present disclosure;

FIG. 3 illustrates a flowchart of a method for determining an anchor position of an interface element according to some embodiments of the present disclosure;

FIG. 4 illustrates a block diagram of an interface display apparatus according to some embodiments of the present disclosure; and

FIG. 5 illustrates a block diagram of a device that can implement multiple embodiments of the present disclosure.

Throughout the drawings, the same or similar reference numerals represent the same or similar elements.

### DETAILED DESCRIPTION OF EMBODIMENTS

It would be appreciated that all user-related data involved in the present technical solution should be obtained and used after user authorization has been gained. In other words, according to the present technical solution, if user’ s personal information is to be used, express consent and authorization from the user are required before obtaining the data; otherwise, the related data should not be collected or used. Further, when the technical solution is being carried out, the behavior of collecting, using and storing the data should strictly comply with the relevant laws and regulations, and necessary technologies and measures should be adopted to protect the user data security and ensure safe use of the data.

Prior to applying the technical solution, in accordance with the relevant laws and regulations, the user should be informed of the type, scope of use, and use scenario of the personal information involved in an appropriate manner, and user authorization should be obtained.

For example, in response to receiving an active request from a user, prompt information is sent to the user to explicitly inform the user that the requested operation would acquire and use the user’s personal information. Therefore, according to the prompt information, the user may decide on his/her own whether to provide the personal information to software or hardware, such as electronic devices, applications, servers or storage media that perform operations of the technical solution of the present disclosure.

As an optional implementation, without limitation, in response to receiving an active request from a user, the method of sending prompt information to the user may, for example, include a pop-up window, where the prompt information may be presented in the form of text in the pop-up window. In addition, the pop-up window may also carry a select control for the user to choose to “agree” or “disagree” to provide the personal information to the electronic device.

The above process of notifying and obtaining the user authorization is only illustrative, and other methods compliant with the provisions of the relevant laws and regulations can also be applied to the implementations of the present disclosure.

Reference below will be made to describe the embodiments of the present disclosure in detail. Although some embodiments of the present disclosure are depicted in the drawings, it would be appreciated that the present disclosure could be implemented in various forms and should not be construed as being restricted to the embodiments described herein. Rather, those embodiments are provided to enable a more thorough and complete understanding of the present disclosure. It is to be understood that the drawings and embodiments of the present disclosure are provided only exemplarily, but not used to limit the protection scope of the present disclosure.

As described herein, the term “includes” or similar expressions are to be read as open-ended terms that mean “includes, but is not limited to.” The term “based on” is to be read as “based at least in part on.” The term “an embodiment” or “the embodiment” is to be read as “at least one embodiment.” The terms “first,” “second,” and the like may refer to different objects or the same object unless explicitly indicated otherwise. Other definitions, explicit and implicit, may be included below.

When a user performs a quick drag operation, since the drag action may result in a small displacement though it has a fast velocity, the system probably misunderstands the user’s intention, which typically results in a delayed response, a jump in anchor positions, a mismatch between the actual stay position and the intended stay position.

As described above, in existing interactive interfaces, the stay position of an interface element is generally determined using a displacement determination method in a single dimension. However, such a method cannot adapt to different user operation habits. For example, some users may determine the anchor position of the interface element through a quick drag gesture, in which case the drag velocity may be high but the drag displacement may be small. A method that determines the anchor position based solely on single-dimensional displacement without considering the drag gesture velocity cannot meet the need for accurately determining the anchor position of the interface element desired by the user, thereby affecting the interaction experience.

To this end, the present disclosure provide an interface display method. The method may include: receiving a gesture input for an interface element, the interface element having multiple candidate anchor positions arranged in an order; determining, at least based on a velocity of the gesture input, a target anchor position from the multiple candidate anchor positions; and displaying the interface element based on the determined target anchor position. With the method, the target anchor position can be determined comprehensively based on the velocity of the user’s gesture input and the position of the drag gesture, to make the anchor position of the interface element more in line with the user’s expectation and thus improve the interactive experience.

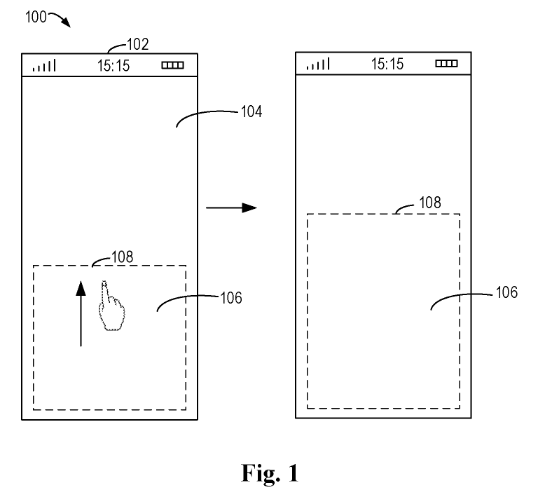

FIG. 1 illustrates a schematic diagram of an example environment 100 where multiple embodiments of the present disclosure can be implemented. As shown therein, the example environment 100 may include a terminal device 102 that may be an electronic device having data processing and display functionalities and equipped with a user interface for user to interact therewith, for example, a smartphone, a tablet, a laptop, a smart wearable device, and the like. The example environment 100 may further include an interface 104 and an interface element 106, where the interface element 106 may include a fixed boundary and a movable boundary 108. In some embodiments, the terminal device 102 can obtain a gesture input from a user, and can operate the interface element 106 on the interface 104 based on the obtained gesture input. It would be appreciated that the interface element is an element on the interaction interface for function triggering, information display, user input, or the like, such as a text box, a status bar, an icon and the like, which is not limited herein.

In some embodiments, the terminal device 102 can obtain a gesture input for the interface element 106 from the user, and can determine, based on the obtained gesture input, a movement direction and a movement distance of the movable boundary 108 of the interface element 106. By way of example, the terminal device 102 can obtain an upward-drag gesture input for the interface element 106 from the user, and can determine, based on the upward-drag gesture input from the user, that the anchor position of the movable boundary 108 of the interface element 106 is to move upwards along with the gesture input, to enlarge the display element 106.

In some embodiments, the interface element 106 has multiple candidate anchor positions arranged in an order. It would be appreciated that the interface element 106 may include a movable boundary 108 and three fixed boundaries, where the multiple candidate anchor positions of the interface element 106 arranged in an order are associated with the movable boundary 108. Based on the predefined multiple anchor positions of the interface element 106 arranged in an order, the terminal device 102 can determine predefined multiple candidate anchor positions of the movable boundary 108 arranged in an order. In some embodiments, the terminal device 102 can sort the multiple candidate anchor positions of the interface element 106, for example, in an ascending or descending order. Specifically, the ascending order causes the display state of the interface element 106 to be enlarged, where the first candidate anchor position in the ascending order allows the interface element 106 to be reduced to the minimum value while the last candidate anchor position allows the interface element 106 to be enlarged to the maximum value; the descending order causes the display state of the interface element 106 to be reduced, where the first candidate anchor position in the descending order allows the interface element 106 to be enlarged to the maximum value while the last candidate anchor position allows the interface element 106 to be reduced to the minimum value.

By way of example, the movable boundary 108 may have predefined multiple candidate anchor positions which may be, for example, positions at different distances away from the bottom of the interface 104. It would be appreciated that the example is provided only illustratively, and the movable boundary 108 may have more candidate anchor positions.

In some embodiments, the terminal device 102 can determine, based on the upward-drag gesture input from the user, that the movable boundary 108 of the interface element 106 is to move upwards. Based on the drag position of the gesture input, the terminal device 102 can determine that the movable boundary 108 is to anchor one of the multiple candidate anchor positions. By way of example, the terminal device 102 can determine, based on the drag position of the gesture input, a candidate anchor position closest to the drag position of the gesture input, and can display the interface element 106 based on the candidate anchor position.

In some embodiments, the terminal device 102 can determine, based on the velocity of the gesture input, that the movable boundary 108 is to anchor at one of the multiple candidate anchor positions. For example, the terminal device 102 can compare the velocity of the gesture input with a velocity threshold (hereinafter referred as first threshold, for ease of description and explanation). If the velocity of the gesture input exceeds the first threshold, the movable boundary 108 of the interface element 106 anchors at the candidate anchor position ranked in the first or last place, such that the position of the movable boundary 108 of the interface element 106 can be quickly changed to two limit values of the multiple candidate anchor positions of the movable boundary 108. For example, if the user’s drag gesture is upward, the position of the movable boundary 108 can be determined as the last candidate anchor position among the multiple candidate anchor positions arranged in the ascending order, to enlarge the interface element 106 to the maximum display state; if the user’s drag gesture is downward, the position of the movable boundary 108 can be determined as the first candidate anchor position among the multiple candidate anchor positions arranged in the ascending order, to reduce the interface element 106 to the minimum display state. The method enables the anchor position of the interface element to be determined quickly and efficiently based only on the velocity of the user’s drag gesture, thus improving the user experience.

In some embodiments, the terminal device 102 can also determine, comprehensively based on the velocity and the drag position of the gesture input, that the movable boundary 108 is to anchor at one of the multiple candidate anchor positions. By way of example, the terminal device 102 can compare the velocity of the gesture input with a velocity threshold (hereinafter referred to as second threshold, for ease of description and explanation), where the second threshold is less than the first threshold. If the velocity of the gesture input exceeds the second threshold but does not exceed the first threshold, the movable boundary 108 of the interface element 106 anchors at a candidate anchor position closest to the current anchor position of the gesture input among the multiple candidate anchor positions. For example, if the user’s drag gesture is upward, the position of the movable boundary 108 can be determined as the following anchor position of the current anchor position among the multiple candidate anchor positions arranged in the ascending order, to enlarge the display state of the interface element 106; if the user’s drag gesture is downward, the position of the movable boundary 108 can be determined as the preceding position of the current anchor position among the multiple candidate anchor positions arranged in the ascending order, to reduce the display state of the interface element 106. By combining the velocity of the gesture input and the current drag position, the present disclosure enables accurate location of the anchor position desired by the user, thereby improving the accuracy of the interface element anchoring on the interface.

It would be appreciated that description about drag of the gesture input is provided only illustratively, and the drag direction of the gesture input may be any direction, which is not limited herein. For example, the drag direction of the gesture input may be obliquely upward. In the process, the terminal device 102 can obtain an obliquely upward gesture input, and can determine, based on the gesture input, a drag displacement of the gesture input in the vertical direction of the interface 104. Based on the drag displacement, the terminal device 102 can determine the anchor position of the display element 106.

It is worth noting that, although reference has been made to FIG. 1 to illustrate the candidate positions of the interface element using the movable boundary, the embodiments of the present disclosure can be applied likewise to other implementations. For example, the candidate anchor positions may be position information on the entire interface element or other parts (e.g., the geometric center).

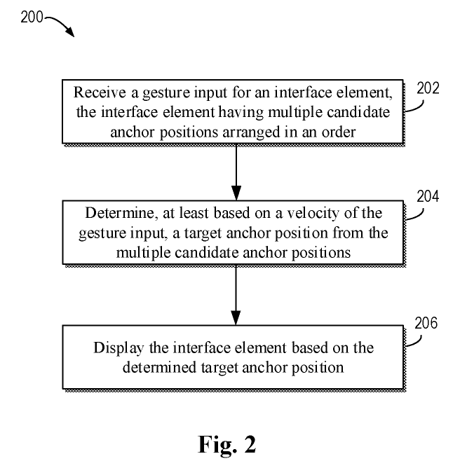

FIG. 2 illustrates a flowchart of an interface display method 200 according to some embodiments of the present disclosure. The method 200 can be executed by a terminal device which may be, for example, the terminal device 102 in the example environment 100. The method 200 includes blocks 202, 204 and 206.

As shown therein, in block 202, a gesture input for an interface element is received, where the interface element has multiple candidate anchor positions arranged in an order. Referring to FIG. 1, the terminal device 102 can obtain a gesture drag input for the interface element 106 from a user, where the drag direction may be any direction. For example, the drag may be dragging the interface element 106 upwards, to cause the movable boundary 108 of the interface element 106 to move upwards, thus enlarging the display of the interface element 106; or the drag may be dragging the interface element 106 downwards, to cause the movable boundary 108 of the interface element 106 to move downwards, thus reducing the display of the interface element 106. In some embodiments, the interface element 106 may have predefined multiple candidate anchor positions arranged in an order, and based on the multiple candidate anchor positions, the movable boundary 108 of the interface element 106 may have predefined multiple candidate anchor positions arranged in an order.

In block 204, at least based on a velocity of the gesture input, a target anchor position is determined from the multiple candidate anchor positions. Referring to FIG. 1, the terminal device 102 can obtain the velocity of the user’s gesture input, and can determine the target anchor position of the interface element 106 based on the velocity.

In block 206, the interface element is displayed based on the determined target anchor position. Referring to FIG. 1, the terminal device 102 can determine the target anchor position of the movable boundary 108 of the interface element 106 based on the determined target anchor position. Having obtained the target anchor position of the movable boundary 108, the terminal device 102 can determine, based on the movable boundary 108 and the fixed boundaries, the size of the interface element 106 and display the interface element 106.

In this way, the present disclosure can determine the target anchor position of the interface element based on the drag velocity of the gesture input, to make the size of the displayed interface element more in line with the user’s expectation, and can quickly determine the target anchor position of the interface element based on the drag velocity, to increase the interaction response velocity while improving the user experience.

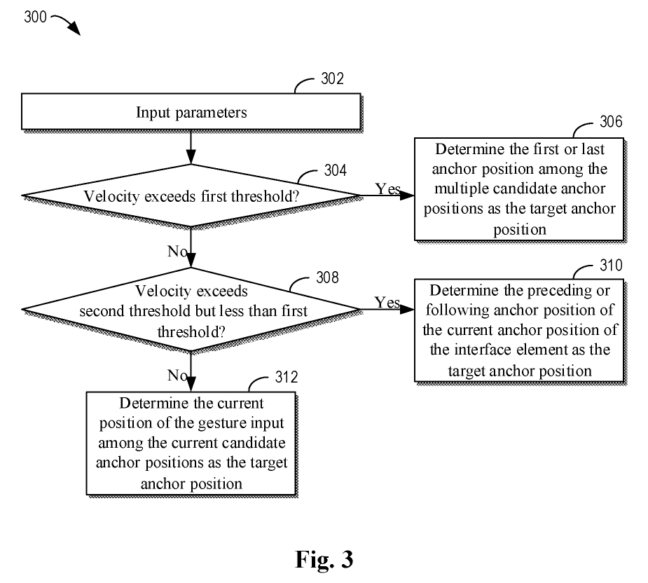

FIG. 3 illustrates a flowchart of a method for determining an anchor position of an interface element according to some embodiments of the present disclosure. As shown therein, the method 300 can be executed by a terminal device which may be, for example, the terminal device 102 in the example environment 100. The method 300 includes blocks 302 through 312.

In block 302, the terminal device 102 obtains input parameters. By way of example, the input parameters may include a drag displacement, a current position and a velocity of the user’s gesture input on the interface 104. In some embodiments, the initial position of the gesture input may be at, or adjacent to, the movable boundary 108 of the interface element 106. In block 304, it is determined whether the velocity exceeds the first threshold. If yes, the method proceeds to block 306 where the first or last candidate anchor position among the multiple candidate anchor positions is determined as the target anchor position. If no, the method proceeds to block 308 where it is determined whether the velocity exceeds the second threshold but does not exceed the first threshold. If yes, the method proceeds to block 310 where the preceding or following anchor position of the current anchor position of the interface element 106 is determined as the target anchor position. If no, the method proceeds to block 312 where the candidate anchor position closest to the current position of the gesture input among the multiple candidate anchor positions is determined as the target anchor position.

In block 306 describe above, in some embodiments, the terminal device 102 can determine the target anchor position based on the direction of the drag. By way of example, if the user’s drag gesture is upward, the position of the movable boundary 108 can be determined as the last candidate anchor position among the multiple candidate anchor positions arranged in the ascending order, to enlarge the interface element 108 to the maximum display state; if the user’s drag gesture is downward, the position of the movable boundary 108 can be determined as the first candidate anchor position among the multiple candidate anchor positions arranged in the ascending order, to reduce the interface element 106 to the minimum display state. In some embodiments, if the user’s drag gesture is upward, the position of the movable boundary 108 can be determined as the last candidate anchor position among the multiple candidate anchor positions arranged in the ascending order, to enlarge the interface element 106 to the maximum display state; if the user’s drag gesture is downward, the position of the movable boundary 108 can be determined as the first candidate anchor position among the multiple candidate anchor positions arranged in the ascending order, to reduce the interface element 106 to the minimum display state.

In block 310 described above, in some embodiments, the terminal device 102 can determine the target anchor position based on the direction of the drag. By way of example, if the user’s drag gesture is upward, the position of the movable boundary 108 can be determined as the following anchor position of the current anchor position among the multiple anchor positions arranged in the ascending order, to enlarge the display state of the interface element 106; if the user’s drag gesture is downward, the position of the movable boundary 108 can be determined as the preceding anchor position of the current anchor position among the multiple anchor positions arranged in the ascending order, to reduce the display state of the interface element 106.

In block 312 described above, in some embodiments, if the user performs gesture drag, the position of the movable boundary 108 can be determined as the candidate anchor position closest to the current position of the gesture input. In the circumstance, in the case that the gesture input moves slowly, the user can accurately control the anchor position of the interface element by means of displacement. By way of example, in the case that the user’s gesture is upward drag, if the current position of the gesture drag is beyond the last anchor position of the movable boundary 108 among the candidate anchor positions arranged in the ascending order (i.e., the current position of the gesture drag is beyond the maximum display state of the interface element 106), the movable boundary 108 still lingers at the last anchor position among the candidate anchor positions arranged in the ascending order, to cause the interface element 106 to be displayed in its maximum display state; in the case that the user’s gesture is downward drag, if the current position of the gesture drag is beyond the first anchor position of the movable boundary 108 among the candidate anchor positions arranged in the ascending order (i.e., the current position of the gesture drag is beyond the minimum display state of the interface element 106), the movable boundary 108 still lingers at the first anchor position among the candidate anchor positions arranged in the ascending order, to cause the interface element 106 to be displayed in its minimum display state.

In some embodiments, if the current position of the gesture drag is not out of the area of the multiple anchor positions of the movable boundary 108 in the ascending order (i.e., the current position of the gesture drag is between the minimum display state and the maximum display state of the interface element 106), the movable boundary 108 anchors at a candidate anchor position closest to the current position of the gesture drag. With the method, if the gesture drag is slow, the target anchor position of the display element can be determined based on the current drag position of the user, such that the size of the display element can be determined comprehensively based on the combination of velocity and position, to better meet the user’s needs.

The example embodiments described above with reference to FIGS. 1-3 provide a method for determining, at least based on a velocity of gesture drag, a target anchor position of an interface element from multiple candidate anchor positions. As compared with the prior art, the method has the following advantages: the target anchor position of the interface element can be determined accurately based on the combination of the gesture drag velocity and the current position of the gesture, which is more accurate than the single-dimensional method based on displacement comparison, and when the user’s drag velocity is great, the target anchor position can be determined directly, to more quickly respond to the user’s drag need and thus improve the user experience.

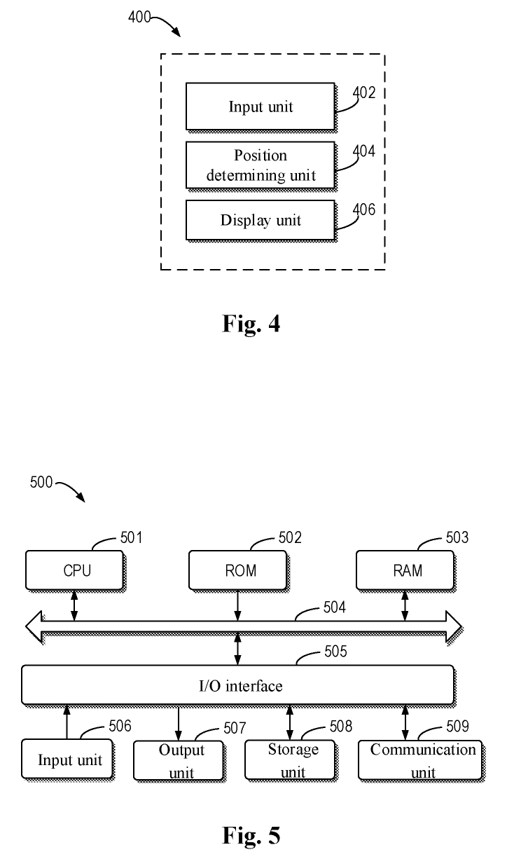

FIG. 4 illustrates a block diagram of an interface display apparatus 400 according to some embodiments of the present disclosure. As shown therein, the apparatus 400 includes an input unit 402 configured to receive a gesture input for an interface element, where the interface element has a multiple candidate anchor positions arranged in order. The apparatus 400 also includes a position determining unit 404 configured to determine, at least based on a velocity of the gesture input, a target anchor position from the multiple candidate anchor positions. The apparatus 400 further includes a display unit 406 configured to display the interface element based on the determined target anchor position.

In some embodiments, the position determining unit 404 can be further configured to: in response to the velocity of the gesture input exceeding a first threshold, determine a first or a last candidate anchor position among the multiple candidate anchor positions as the target anchor position.

In some embodiments, a current anchor position of the interface element is one of the multiple candidate anchor positions, and the position determining unit 404 can be further configured to: in response to the velocity exceeding a second threshold but not exceeding the first threshold, determine a preceding or a following anchor position of the current anchor position of the interface element as the target anchor position, the second threshold being less than the first threshold.

In some embodiments, the position determining unit 404 can be further configured to: in response to the velocity not exceeding the second threshold, determine a candidate anchor position closest to the current position of the gesture input among the multiple candidate anchor positions as the target anchor position.

In some embodiments, the position determining unit 404 can be further configured to: select the target anchor position based on a direction of the velocity.

In some embodiments, the interface element of the apparatus 400 has a movable boundary, and a position of the movable boundary is determined based on the multiple candidate anchor positions.

In some embodiments, an initial position of the gesture input of the apparatus 400 is at or adjacent to the movable boundary.

FIG. 5 illustrates an example block diagram of an example device 500 that can implement embodiments of the present disclosure. As shown therein, the device 500 may include a central processing unit (CPU) and/or graphics processing unit (GPU) 501 which can execute various actions and processing based on programs stored in a Read Only Memory (ROM) 502 or a program loaded from a storage unit 508 to a Random Access Memory (RAM) 503. RAM 503 stores therein various programs and data required for operations of the device 500. The CPU/GPU 501, the ROM 502, and the RAM 503 are connected to one another via a bus 504. An input/output (I/O) interface 505 is also connected to the bus 504. Although not shown in FIG. 5, the device 500 may further include a coprocessor.

A plurality of components in the device 500 may be connected to the I/O interface 505, including: an input unit 506 including, for example, a keyboard, a mouse, and the like; an output unit 507 including various types of displays, loudspeakers, and the like; a storage unit 508 including, for example, a magnetic disk, a compact disc, or the like; and a communication unit 509, for example, a network card, a modem, a wireless communication transceiver, or the like. The communication unit 509 can allow the device 500 to exchange information/data with other devices through a computer network such as Internet, and/or various kinds of telecommunication networks.

The various methods or processes described above can be performed by the CPU/GPU 501. For example, the method may be implemented as computer software programs that are tangibly included in a machine readable medium, e.g., the storage unit 508. In some embodiments, part or all of the computer programs may be loaded and/or mounted onto the device 500 via ROM 502 and/or communication unit 509. When the computer program is loaded to the RAM 503 and executed by the CPU/GPU 501, one or more steps or postures of the method or process as described above can be executed.

In some embodiments, the method and process described above may be implemented as a computer program product. The computer program product may include a computer readable storage medium having stored thereon computer readable program instructions for performing various aspects of the present disclosure.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a Random Access Memory (RAM), a Read-Only Memory (ROM), an Erasable Programmable Read-Only Memory (EPROM or Flash memory), a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals sent through a wire.

Computer readable program instructions described herein can be downloaded to corresponding computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the corresponding computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a Local Area Network (LAN) or a Wide Area Network (WAN), or the connection may be made to an external computer (for example, through the Internet using an Internet Service Provider). In some embodiments, electronic circuitry including, for example, programmable logic circuitry, Field-Programmable Gate Arrays (FPGAs), or Programmable Logic Arrays (PLAs) may execute the computer readable program instructions by utilizing state information of the computer readable program instructions to personalize the electronic circuitry, in order to perform aspects of the present disclosure.

These computer readable program instructions may be provided to a processing unit of a general purpose computer, special purpose computer, or other programmable data processing device to produce a machine, such that the instructions, when executed via the processing unit of the computer or other programmable data processing device, create apparatuses for implementing the functions/actions specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored thereon includes an article of manufacture including instructions which implement aspects of the functions/actions specified in the flowchart and/or block diagram block or blocks.

The computer readable program instructions may also be loaded onto a computer, other programmable data processing devices, or other devices to cause a series of operational steps to be performed on the computer, other programmable devices or other devices to produce a computer implemented process, such that the instructions which are executed on the computer, other programmable devices, or other devices implement the functions/actions specified in the flowchart and/or block diagram block or blocks.

The flowchart and block diagrams illustrate the architecture, functionality, and operation of possible implementations of systems, methods and computer program products according to various embodiments of the present disclosure. In this regard, each block in the flowchart or block diagrams may represent a module, snippet, or portion of code, which includes one or more executable instructions for implementing the specified logical function(s). In some alternative implementations, the functions noted in the block may occur out of the order noted in the images. For example, two blocks in succession may, in fact, be executed substantially concurrently, or the blocks may sometimes be executed in the reversed order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or actions, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the claims:

1. A display method, comprising:
receiving a gesture input for an interface element, the interface element having multiple candidate anchor positions arranged in an order;
determining, at least based on a velocity of the gesture input, a target anchor position from the multiple candidate anchor positions; and
displaying the interface element based on the determined target anchor position.

2. The method of claim 1, wherein determining the target anchor position from the multiple candidate anchor positions comprises:
in response to the velocity of the gesture input exceeding a first threshold, determining a first or a last candidate anchor position among the multiple candidate anchor positions as the target anchor position.

3. The method of claim 2, wherein a current anchor position of the interface element is one of the multiple candidate anchor positions, and determining the target anchor position from the multiple candidate anchor positions comprises:
in response to the velocity exceeding a second threshold but not exceeding the first threshold, determining a preceding or a following anchor position of the current anchor position of the interface element as the target anchor position, the second threshold being less than the first threshold.

4. The method of claim 3, wherein determining the target anchor position from the multiple candidate anchor positions comprises:
in response to the velocity not exceeding the second threshold, determining a candidate anchor position closest to a current position of the gesture input among the multiple candidate anchor positions as the target anchor position.

5. The method of claim 3, wherein determining the target anchor position from the multiple candidate anchor positions comprises:
selecting the target anchor position based on a direction of the velocity.

6. The method of claim 1, wherein the interface element has a movable boundary, and a position of the movable boundary is determined based on the multiple candidate anchor positions.

7. The method of claim 6, wherein an initial position of the gesture input is at or adjacent to the movable boundary.

8. A device, comprising:
a processor; and
a memory coupled to the processor and having instructions stored therein, wherein the instructions, when executed by the processor, cause the device to perform a method comprising:
receiving a gesture input for an interface element, the interface element having multiple candidate anchor positions arranged in an order;
determining, at least based on a velocity of the gesture input, a target anchor position from the multiple candidate anchor positions; and
displaying the interface element based on the determined target anchor position.

9. The device of claim 1, wherein determining the target anchor position from the multiple candidate anchor positions comprises:
in response to the velocity of the gesture input exceeding a first threshold, determining a first or a last candidate anchor position among the multiple candidate anchor positions as the target anchor position.

10. The device of claim 2, wherein a current anchor position of the interface element is one of the multiple candidate anchor positions, and determining the target anchor position from the multiple candidate anchor positions comprises:
in response to the velocity exceeding a second threshold but not exceeding the first threshold, determining a preceding or a following anchor position of the current anchor position of the interface element as the target anchor position, the second threshold being less than the first threshold.

11. The device of claim 3, wherein determining the target anchor position from the multiple candidate anchor positions comprises:
in response to the velocity not exceeding the second threshold, determining a candidate anchor position closest to a current position of the gesture input among the multiple candidate anchor positions as the target anchor position.

12. The device of claim 10, wherein determining the target anchor position from the multiple candidate anchor positions comprises:
selecting the target anchor position based on a direction of the velocity.

13. The device of claim 8, wherein the interface element has a movable boundary, and a position of the movable boundary is determined based on the multiple candidate anchor positions.

14. The device of claim 13, wherein an initial position of the gesture input is at or adjacent to the movable boundary.

15. A non-transitory computer-readable storage medium having computer-executable instructions stored thereon, wherein the computer-executable instructions are executed by a processor to perform a method comprising
receiving a gesture input for an interface element, the interface element having multiple candidate anchor positions arranged in an order;
determining, at least based on a velocity of the gesture input, a target anchor position from the multiple candidate anchor positions; and
displaying the interface element based on the determined target anchor position.

16. The medium of claim 15, wherein determining the target anchor position from the multiple candidate anchor positions comprises:
in response to the velocity of the gesture input exceeding a first threshold, determining a first or a last candidate anchor position among the multiple candidate anchor positions as the target anchor position.

17. The medium of claim 16, wherein a current anchor position of the interface element is one of the multiple candidate anchor positions, and determining the target anchor position from the multiple candidate anchor positions comprises:
in response to the velocity exceeding a second threshold but not exceeding the first threshold, determining a preceding or a following anchor position of the current anchor position of the interface element as the target anchor position, the second threshold being less than the first threshold.

18. The medium of claim 17, wherein determining the target anchor position from the multiple candidate anchor positions comprises:
in response to the velocity not exceeding the second threshold, determining a candidate anchor position closest to a current position of the gesture input among the multiple candidate anchor positions as the target anchor position.

19. The medium of claim 17, wherein determining the target anchor position from the multiple candidate anchor positions comprises:
selecting the target anchor position based on a direction of the velocity.

20. The device of claim 15, wherein the interface element has a movable boundary, and a position of the movable boundary is determined based on the multiple candidate anchor positions.
